(19) United States
(12) Patent Application Publication
(10) Pub. No.: US 2022/0215221 A1
(43) Pub. Date: Jul. 7, 2022

(54) BIOMETRIC ACTUATED BALANCE-REVEALING DEBIT CARD

(71) Applicant: Peter Renteria, Santa Maria, CA (US)

(72) Inventor: Peter Renteria, Santa Maria, CA (US)

(21) Appl. No.: 17/142,061

(22) Filed: Jan. 5, 2021

(51) Int. Cl. G06K 19/077; G06K 19/07; G06Q 20/34; G06Q 20/10

(52) U.S. Cl. CPC G06K 19/07707; G06K 19/0708; G06Q 20/108; G06Q 20/341; G06K 19/0718

(57) ABSTRACT

The biometric actuated balance-displaying debit card gives users a secure and convenient method to view their account balance. It is of utmost convenience to be able to safely view the balance of one's account on the card used to make the purchase. Once the built-in fingerprint scanner recognizes the user's fingerprint, the card ascertains the account balance and displays that number value on the LED panel. Therefore, card users are able to use the fingerprint scanner when only they will be able to read the balance value for maximum security. If the card is to come into other hands, the fingerprint scanner will not recognize the print of other fingers and the balance will not be displayed.

### BACKGROUND

A debit card is a plastic payment card that can be used instead of cash when making purchases. It is similar to a credit card, but unlike a credit card, the money is immediately transferred directly from the cardholder's bank account when performing any transaction. Some cards might carry a stored value with which a payment is made, while most relay a message to the cardholder's bank to withdraw funds from a payer's designated bank account. In some cases, the primary account number is assigned exclusively for use on the Internet and there is no physical card. There have been no products available as original equipment or as an aftermarket to address this problem.

All ATM machines, at a minimum, will permit cash withdrawals of customers of the machine's owner (if a bank-operated machine) and for cards that are affiliated with any ATM network the machine is also affiliated. Most banks and credit unions will permit routine account-related banking transactions at the bank's own ATM, including deposits, checking the balance of an account, and transferring money between accounts. For other types of transactions through telephone or online banking, this may be performed with an ATM card without in-person authentication. This includes account balance inquiries, electronic bill payments, or in some cases, online purchases There have been no products available as original equipment or as an aftermarket to address this problem either.

There exists a need for a biometric actuated balance-revealing debit card that is not being met by any known or disclosed device or system of present.

### SUMMARY OF THE INVENTION

The biometric actuated balance-displaying debit card gives users a secure and convenient method to view their account balance. One needs to know their account balance, or at least know that the balance is sufficient, in order to successfully make a purchase and payment by debit card. In all cases when a payment occurs, the card is necessary. Thus it is of utmost convenience to be able to safely view the balance of one's account on the card used to make the purchase. Once the built-in fingerprint scanner recognizes the user's fingerprint, the card ascertains the account balance and displays that number value on the LED panel. Therefore, card users are able to use the fingerprint scanner when only they will be able to read the balance value for maximum security. If the card is to come into other hands, the fingerprint scanner will not recognize the print of other fingers and the balance will not be displayed.

### BRIEF DESCRIPTION OF THE DRAWINGS

FIG. 1 is a front view of the biometric actuated balance-revealing debit card in accordance with an embodiment of the present disclosure.

FIG. 2 is a front view of the power sleeve for the biometric actuated balance-revealing debit card in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure the term ‘inductive’ is used to refer to a power transfer through an inductor electronic device. The term ‘coupler’ refers to a physical transfer of information, properties and characteristics.

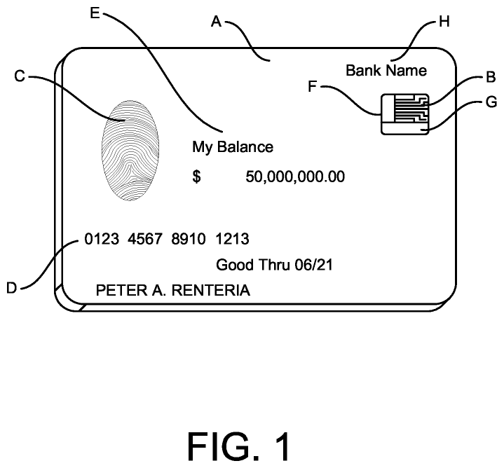

FIG. 1 is a front view of the biometric actuated balance-revealing debit card in accordance with an embodiment of the present disclosure. The smart banking card A has several features not possessed by a regular debit or credit card. On the front of the card is a finger print scanner C. When the biometric indicia indicates the fingerprint to be a match to the account owner's fingerprint, the light-emitting diodes on the front display E give the balance of the associated account. Also on the card is the card information D, the account host or bank H, the micro chip B, the logic circuit F and the inductive power coupler G.

a power sleeve configured complementary to the composite substrate and the plurality of components thereof and comprising an electronic port, a charge indicator and a light power panel with an inductive power coupler.

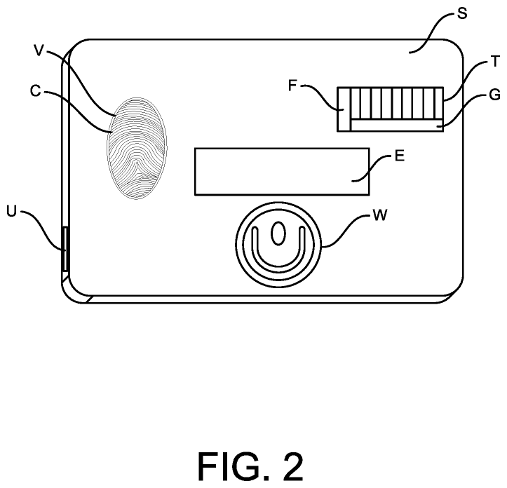

FIG. 2 is a front view of the power sleeve for the biometric actuated balance-revealing debit card in accordance with an embodiment of the present disclosure. The depiction includes the power sleeve substrate S, an electronic port U, a charge indicator W and a light power panel T with an inductive power coupler G. Embodiments of the power sleeve also include logic circuits F, display E and biometric indicia C including finger print readers, scanners and iris reading technologies. The biometric indicia C, the account display which is electronic, may be disposed on the card composite substrate either or and in addition to a biometric indicia on the power sleeve depending on passive and active power designs for the electronic banking card. A backlighting V for the biometric indicia also indicates a reading is in progress.

An adjacency of the card composite substrate to the power sleeve creates active circuits and active components where the card composite substrate and the multiple components thereof are in a passive state prior to an inductive coupling of the two. Biometric activation occurs on the card substrate and on the power sleeve depending on where the biometric readers are located. An embodiment of the present disclosure also includes a partial overlap adjacency of the card substrate with the power sleeve so that a fingerprint reader on the card substrate is still available for a positive indicator when the power sleeve is adjacent the card substrate.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. An electronic banking card comprising:
a composite substrate for a plurality of components comprising a programmable logic circuit, an account display, an account owner biometric indicia, an account host indicia and an inductive power coupler;
a microchip comprising the programmable logic circuit in communication with the account display, the biometric indicia and the inductive power coupler; and
a power sleeve configured complementary to the composite substrate and the plurality of components thereof and comprising an electronic port, a charge indicator and a light power panel with an inductive power coupler.

2. The electronic banking card of claim 1, wherein the programmable logic circuit is configured to interface with a card reader logic via the microchip to exchange account information.

3. The electronic banking card of claim 1, wherein the microchip is configured to receive an account balance and communicate it to the account display.

4. The electronic banking card of claim 1, wherein the account owner biometric indicia is a fingerprint reader.

5. The electronic banking card of claim 1, wherein the account owner biometric indicia is a reader of an iris of a human eye.

6. The electronic banking card of claim 1, wherein the inductive power coupler receives electric charge from the light power panel via the inductive couplers.

7. The electronic banking card of claim 1, further comprising an encrypted banking card number shown on the account display based on a positive biometric indicia.

8. The electronic banking card of claim 1, further comprising an account host indicia shown on the account display based on a positive biometric indicia.

9. The electronic banking card of claim 1, further comprising a darkening of the account display based on a negative biometric indicia.

10. The electronic banking card of claim 1, wherein the light power panel is a solar light panel configured to generate an electric charge from light to power the electronic banking card.

11. The electronic banking card of claim 1, further comprising a back light for the account owner biometric indicia configured to indicate a reading of the indicia in progress.

12. The electronic banking card of claim 1, wherein the electronic port comprises a USB (Universal Serial Bus) and a mini USB and a micro USB port.

13. The electronic banking card of claim 1, wherein the charge indicator is a visual indicator based on a coupling of the microchip with the inductive power couplers and the light power panel.

14. The electronic banking card of claim 1, wherein the composite substrate is complementary to the power sleeve based on an adjacency thereto.

15. An electronic banking card comprising:
a composite substrate for a plurality of components comprising a programmable logic circuit, an account owner indicia, an account host indicia and an inductive power coupler;
a power sleeve configured complementary to the composite substrate and comprising an electronic port, a charge indicator, a light power panel with an inductive coupler, an account display and an account owner biometric indicia; and
a microchip disposed on the composite substrate and comprising the programmable logic circuit in communication with the account display, the biometric indicia and the inductive power coupler.

16. The electronic banking card of claim 15, wherein the account owner biometric indicia is a fingerprint reader.

17. The electronic banking card of claim 15, wherein the light power panel is a solar light panel configured to generate an electric charge from light to power the electronic banking card.

18. The electronic banking card of claim 15, further comprising a back light for the account owner biometric indicia configured to indicate a reading of the indicia in progress.

19. The electronic banking card of claim 15, wherein the charge indicator is a visual indicator based on a coupling of the microchip with the inductive power couplers and the light power panel.

20. The electronic banking card of claim 15, wherein the composite substrate is complementary to the power sleeve based on an adjacency thereto.
